(19) United States
(12) Patent Application Publication
(10) Pub. No.: US 2011/0051956 A1
(43) Pub. Date: Mar. 3, 2011

(54) APPARATUS AND METHOD FOR REDUCING NOISE USING COMPLEX SPECTRUM

(75) Inventors: So-Young JEONG, Seoul (KR); Kyu-Hong KIM, Suwon-si (KR); Kwang-Cheol OH, Yongin-si (KR); Jae-Hong JEONG, Yongin-si (KR)

(73) Assignee: SAMSUNG ELECTRONICS CO., LTD., Suwon-si (KR)

(21) Appl. No.: 12/862,026

(22) Filed: Aug. 24, 2010

(30) Foreign Application Priority Data
Aug. 26, 2009 (KR) 10-2009-79209

(51) Int. Cl. H04B 15/00

(52) U.S. Cl. 381/94.1

(57) ABSTRACT

An apparatus and method reduce noise in a complex spectrum domain to extract a target signal from input signals containing noise and target speech. Noise estimation may be performed through a filter with a filter learning coefficient that is updated according to a prior-signal-to-noise ratio (prior-SNR). Also, noise estimation accuracy may be improved by using confidential weighted scores. The target signal may be extracted by representing candidates of the target signal as at least two circles in the complex spectrum domain using the estimated noise and then geometrically calculating the intersections of the circles.

### CROSS-REFERENCE TO RELATED APPLICATION(S)

This application claims the benefit under 35 U.S.C. §119(a) of Korean Patent Application No. 10-2009-79209, filed on Aug. 26, 2009, the entire disclosure of which is incorporated herein by reference for all purposes.

### BACKGROUND

1. Field

The following description relates to a technique of reducing noise to extract a target signal from mixed signals received from two or more microphones.

2. Description of the Related Art

With an increase in demand for acquiring clean input sound from small-sized mobile devices, research into microphone arrays having high noise reduction performance with a small amount of calculations are actively underway.

An example of a noise reduction method developed as the results of such research is a method which applies appropriate linear filtering to a power spectrum of a mixed signal of a target sound signal and an interference noise signal to extract only the target sound signal.

However, the method is available only under an assumption that the phases of noise signals are orthogonal to the phase of a target sound signal or that the amplitudes of the noise signals are the same but with different phases, and thus there are difficulties in applying the method to general environments.

### SUMMARY

In one general aspect, there is provided an apparatus for reducing noise to extract a target signal contained in input signals received through at least two microphones, the apparatus including: a first noise estimator configured to estimate first noise using a filter including a filter learning coefficient configured to be updated according to a prior signal-to-noise ratio.

The apparatus may further include a second noise estimator configured to estimate second noise using: the first noise, and a confidential weighted score that is determined based on a signal-to-noise ratio.

The apparatus may further include that the confidential weighted score is determined based on the prior signal-to-noise ratio.

The apparatus may further include that the confidential weighted score is determined based on a flattened noisy speech power using minima tracking.

The apparatus may further include: a target signal estimator configured to estimate the target signal by: representing the target signal as at least two circles in a complex spectrum domain, and determining intersections of the circles, wherein the input signals are set as centers of the circles and the first noise is set as a radius of each circle.

The apparatus may further include: a target signal estimator configured to estimate the target signal by: representing the target signal as at least two circles in a complex spectrum domain, and determining intersections of the circles, wherein the input signals are set as centers of the circles and the second noise is set as a radius of each circle.

In another general aspect, there is provided an apparatus for reducing noise to extract a target signal included in input signals received through at least two microphones, the apparatus including: a first noise estimator configured to estimate first noise using an adaptive blocking matrix, and a second noise estimator configured to estimate second noise using: the first noise, and a confidential weighted score that is defined based on a signal-to-noise ratio.

The apparatus may further include that the confidential weighted score is defined based on a prior signal-to-noise ratio.

The apparatus may further include that the confidential weighted score is defined based on a flattened noisy speech power using minima tracking.

The apparatus may further include: a target signal estimator configured to estimate the target signal by: representing the target signal as at least two circles in a complex spectrum domain, and determining intersections of the circles, wherein the input signals are set as centers of the circles and the second noise is set as a radius of each circle.

In another general aspect, there is provided a method of reducing noise to extract a target signal included in input signals received through at least two microphones, the method including: estimating first noise through a filter including a filter learning coefficient that is updated according to an adaptive blocking matrix or a prior signal-to-noise ratio.

The method may further include estimating second noise using: the first noise, and a confidential weighted score that is defined based on a signal-to-noise ratio.

The method may further include estimating the target signal by: representing the target signal as at least two circles in a complex spectrum domain, and obtaining intersections of the circles, wherein the input signals are set as centers of the circles and the first noise or the second noise is set as a radius of each circle.

The method may further include that the confidential weighted score is defined based on a prior signal-to-noise ratio.

The method may further include that the confidential weighted score is defined based on a flattened noisy speech power using minima tracking.

Other objects, features and advantages may be apparent from the following description, the drawings, and the claims.

### BRIEF DESCRIPTION OF THE DRAWINGS

FIG. 1 is a diagram illustrating an example noise reduction apparatus.

FIG. 2 is a diagram showing an example first noise estimator of the noise reduction apparatus illustrated in FIG. 1.

FIG. 3 is a diagram showing another example first noise estimator of the noise reduction apparatus illustrated in FIG. 1.

FIG. 4 is a diagram showing an example second noise estimator of the noise reduction apparatus illustrated in FIG. 1.

FIG. 5 is a diagram illustrating an example target signal estimator of the noise reduction apparatus illustrated in FIG. 1.

FIG. 6 is a view for explaining a target signal estimating method that is performed by the target signal estimator.

FIG. 7 is a flowchart of an example noise reduction method.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

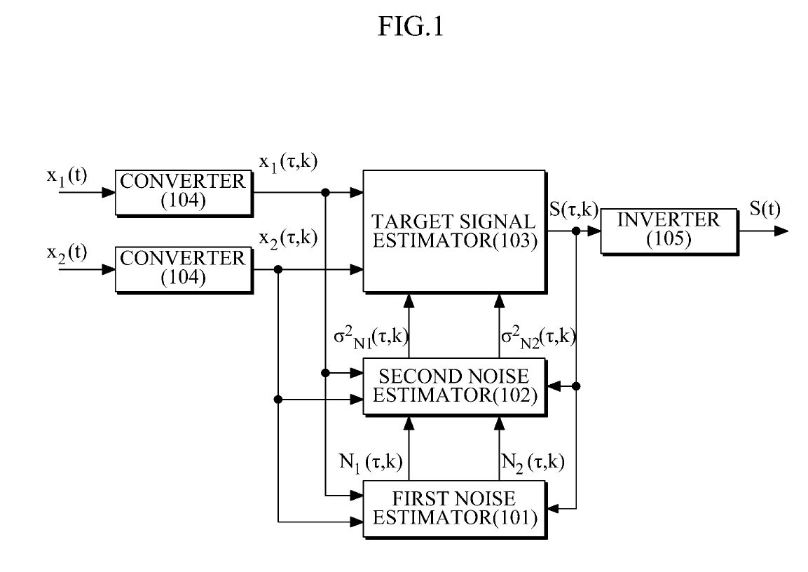

FIG. 1 is a diagram illustrating an example noise reduction apparatus 100.

The noise reduction apparatus 100 may be used to extract a target signal contained in input signals that are received from two or more microphones. For example, the noise reduction apparatus 100 may remove noise from input signals received through a dual-channel microphone, extracting only a target signal from the input signals.

Referring to FIG. 1, the noise reduction apparatus 100 may include a first noise estimator 101, a second noise estimator 102, a target signal estimator 103, two converters 104, and an inverter 105.

Input signals x₁(t) and x₂(t) may be converted into X₁(τ,k) and X₂(τ,k), which are signals in a complex spectrum domain, through the converters 104, wherein τ is a variable indicating a time period and k is a variable indicating a frequency. The signals X₁(τ,k) and X₂(τ,k) may be input to the target signal estimator 103. The target signal estimator 103 may remove noise from the signals X₁ (τ,k) and X₂(τ,k) and may output a target signal S(τ,k). The target signal S(τ,k) may be converted into a signal S(t), which is a signal in a time domain, through the inverter 105.

Noise that will be removed by the target signal estimator 103 may be noise that may be estimated by the first noise estimator 101 or the second noise estimator 102. For example, the target signal S(τ,k) may be obtained by subtracting noise signals N₁(τ,k) and N₂(τ,k) estimated by the first noise estimator 101 from the input signals X₁(τ,k) and X₂(τ,k), respectively. As another example, the target signal S(τ,k) may be obtained by subtracting noise signals σ²_{N1}(τ,k) and σ²_{N2}(τ,k) estimated by the second noise estimator 102 from the input signals X₁(τ,k) and X₂(τ,k).

FIG. 1 shows an example in which the first noise estimator 101 first estimates noise, then the second noise estimator 102 secondarily performs noise estimation thus achieving more improved noise estimation accuracy, and thereafter noise signals σ²_{N1}(τ,k) and σ²_{N2}(τ,k) estimated by the second noise estimator 102 are input to the target signal estimator 103. However, it is also possible that the output of the first noise estimator 101 is directly input to the target signal estimator 103, not via the second noise estimator 102.

The first noise estimator 101 may estimate the noise signals N₁(τ,k) and N₂(τ,k) which are first noise using an adaptive blocking matrix. Alternatively, the first noise estimator 101 may estimate the noise signals N₁(τ,k) and N₂(τ,k) using filters with learning coefficients which are updated according to a prior signal-to-noise ratio (prior-SNR).

The second noise estimator 102 may improve the noise estimation accuracy using confidential weighted scores. The confidential weighted scores may depend on a signal-to-noise ratio (SNR). For example, the noise signals σ²_{N1}(τ,k) and σ²_{N2}(τ,k) estimated by the second noise estimator 102 may be values obtained by appropriately processing the noise signals N₁(τ,k) and N₂(τ,k) estimated by the first noise estimator 101 using confidential weighted scores. The confidential weighted scores may be defined based on a sigmoid function using the prior-SNR. Alternatively, the confidential weighed scores may be defined based on a sigmoid function using a ratio of a flattened noisy speech power to the original noisy speech power using the minima tracking technique. The minima tracking may track a minimum power spectrum.

The target signal estimator 103 may estimate the target signal S(τ,k) by separating noise from the input signals X₁(τ,k) and X₂(τ,k) using the noise signals N₁(τ,k) and N₂(τ,k) estimated by the first noise estimator 101 or the noise signals σ²_{N1}(τ,k) and σ²_{N2}(τ,k) estimated by the second noise estimator 102. At this time, the target signal estimator 103 may estimate the target signal S(τ,k) geometrically in a complex spectrum domain.

For example, the target signal estimator 103 may estimate the target signal S(τ,k) by representing candidates of a target signal as at least two circles in a complex spectrum domain and obtaining intersections of the circles, wherein the input signals X₁(τ,k) and X₂(τ,k) are set as the centers of the circles, and the noise signals N₁(τ,k) and N₂(τ,k) estimated by the first noise estimator 101 are set as the radiuses of the respective circles.

As another example, the noise signals σ²_{N1}(τ,k) and σ²_{N2}(τ,k) estimated by the second noise estimator 102 may be set as the radiuses of the respective circles.

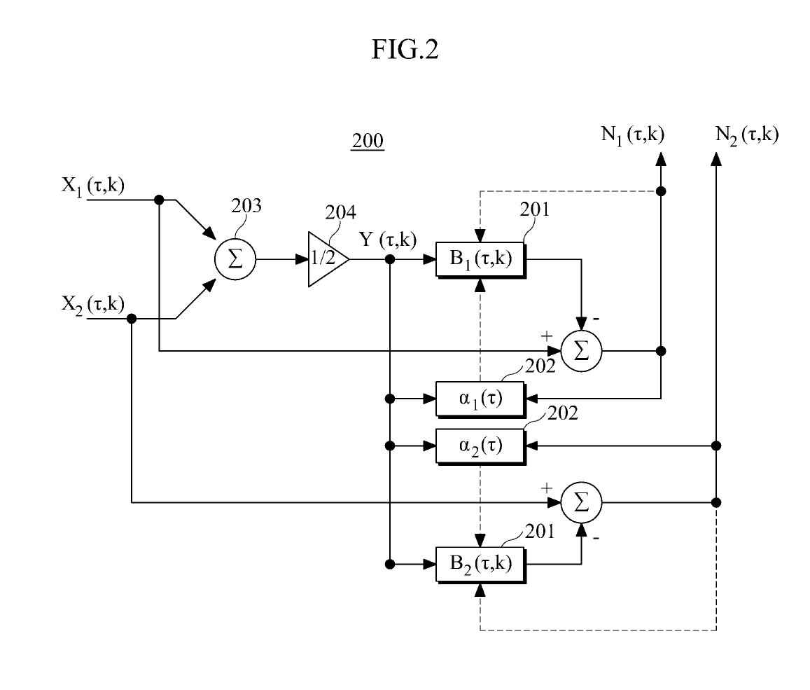

FIG. 2 is a diagram showing an example first noise estimator 200.

Referring to FIG. 2, the first noise estimator 200 may include filtering units 201 and update units 202 for updating the filtering units 201.

As shown in FIG. 2, input signals X₁(τ,k) and X₂(τ,k) may be converted into a fixed beamformer signal Y(τ,k) through a signal synthesizer 203 and an amplifier 204. Noise signals N₁(τ,k) and N₂(τ,k) may be obtained by subtracting a filtered signal of the fixed beamformer signal Y(τ,k) from the respective input signals X₁(τ,k) and X₂(τ,k). For example, filters B₁(τ,k) and B₂(τ,k) of the filtering units 201 may be updated by filter learning coefficients α₁(τ) and α₂(τ) and the estimated noise signals N₁(τ,k) and N₂(τ,k). The filter learning coefficients α₁(τ) and α₂(τ) may be updated according to a posterior-SNR.

This process will be described in detail with reference to the equations, below.

First, the fixed beamformer signal Y(τ,k) may be expressed by Equation 1.

$$Y ( τ , k ) = \frac{1}{2} ( {X}_{1} ( τ , k ) + {X}_{2} ( τ , k ) ) \qquad ( 1 )$$

Also, a noise signal for each channel may be calculated as follows.

Nᵢ(τ,k)=Xᵢ(τ,k)−Y(τ,k)Bᵢ(τ,k) (2)

In Equation 2, Bᵢ(τ,k) may be input into a normalized least mean square error minimization (NLMS) algorithm as follows.

$${B}_{i} ( τ + 1 , k ) = {B}_{i} ( τ , k ) + {α}_{i} ( τ ) \cdot \frac{Y ( τ , k ) \cdot {N}_{i} ( τ , k )}{{\vert Y ( τ , k ) \vert}^{2}} \qquad ( 3 )$$

In Equation 3, αᵢ(τ) represents a filter learning coefficient, which may be updated according to a posterior SNR, as follows.

$${α}_{i} ( τ ) = ( 1 - λ ) {α}_{i} ( τ - 1 ) + λ \frac{{\sum }_{k} \vert Y ( τ , k ) \vert}{{\sum }_{k} \vert {N}_{i} ( τ , k ) \vert} \cdot η \qquad ( 4 )$$

It can be seen in Equation 4 that the filter learning coefficient αᵢ(τ) may be updated according to a ratio of the fixed beamformer signal Y(τ,k) to the estimated noise signal Nᵢ(τ,k).

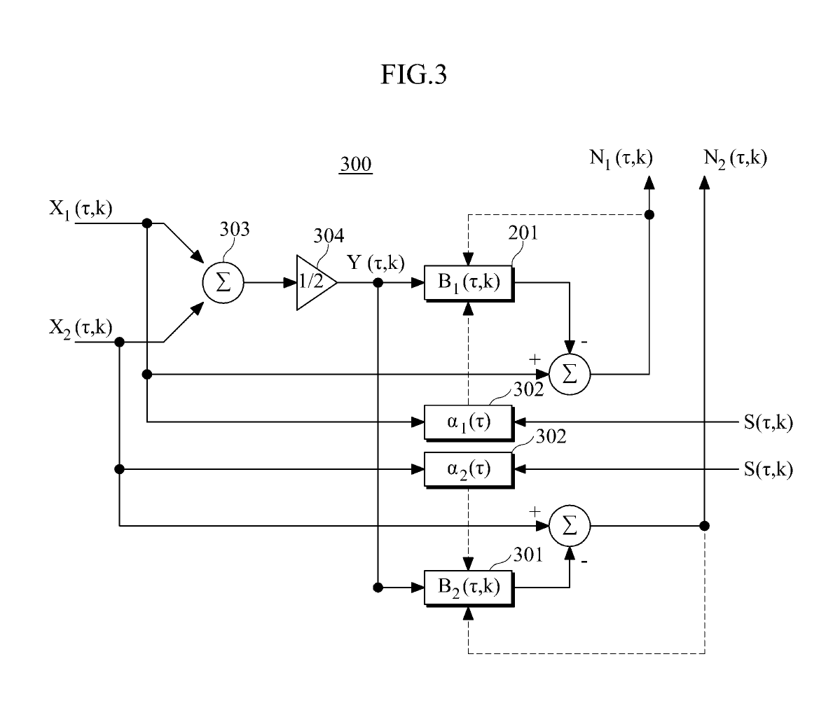

FIG. 3 is a diagram showing another example first noise estimator 300 of the noise reduction apparatus 100 illustrated in FIG. 1.

Referring to FIG. 3, the first noise estimator 300 may include filtering units 301 and update units 302 for updating filters of the filtering units 301.

As shown in FIG. 3, input signals X₁(τ,k) and X₂(τ,k) may be converted into a fixed beamformer signal Y(τ,k) via a signal synthesizer 303 and an amplifier 304. Noise signals N₁(τ,k) and N₂(τ,k) may be obtained by subtracting a filtered signal of the fixed beamformer signal Y(τ,k) from the respective input signals X₁(τ,k) and X₂(τ,k). For example, filters B₁(τ,k) and B₂(τ,k) of the filtering units 301 may be updated by filter learning coefficients α₁(τ) and α₂(τ) and the estimated noise signals N₁(τ,k) and N₂(τ,k). The filter learning coefficients α₁(τ) and α₂(τ) may be updated according to a prior-SNR.

This process will be described in detail using Equations, below.

First, the fixed beamformer signal Y(τ,k) may be expressed by Equation 5.

$$Y ( τ , k ) = \frac{1}{2} ( {X}_{1} ( τ , k ) + {X}_{2} ( τ , k ) ) \qquad ( 5 )$$

Also, a noise signal for each channel may be calculated as follows.

Nᵢ(τ,k)=Xᵢ(τ,k)−Y(τ,k)Bᵢ(τ,k) (6)

In Equation 6, Bᵢ(τ,k) may be input into the NLMS algorithm as follows.

$${B}_{i} ( τ + 1 , k ) = {B}_{i} ( τ , k ) + {α}_{i} ( τ ) \cdot \frac{Y ( τ , k ) \cdot {N}_{i} ( τ , k )}{{\vert Y ( τ , k ) \vert}^{2}} \qquad ( 7 )$$

In Equation 7, αᵢ(τ) represents a filter learning coefficient, which may be updated according to a prior-SNR, as follows.

$${α}_{i} ( τ ) = ( 1 - λ ) {α}_{i} ( τ - 1 ) + λ \frac{{\sum }_{k} \vert S ( τ - 1 , k ) \vert}{{\sum }_{k} \vert {X}_{i} ( τ - 1 , k ) \vert} \cdot η \qquad ( 8 )$$

It can be seen in FIG. 8 that the filter learning coefficient αᵢ(τ) may be updated according to a ratio of the fixed beamformer signal Y(τ,k) to the estimated noise Nᵢ(τ,k).

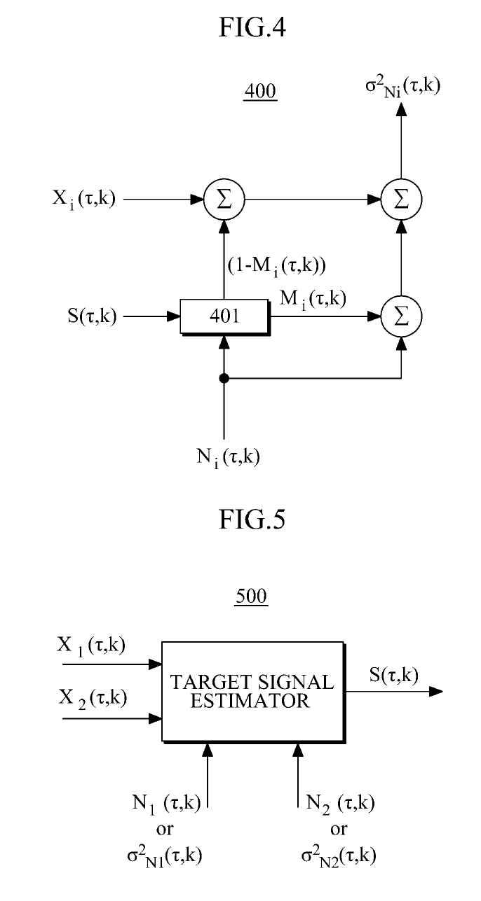

FIG. 4 is a diagram showing an example second noise estimator 400.

The second noise estimator 400 may estimate second noise based on noise estimated by the first noise estimator 200 or 300 and confidential weighted scores in order to improve an accuracy of the noise estimated by the first noise estimator 200 or 300. For the estimation of the second noise, the second noise estimator 400 may include a mask filter 401 using confidential weighted scores.

In FIG. 4, Mᵢ(τ,k) represents a confidential weighted score. The confidential weighted score may be defined in consideration of SNR, for example, based on a prior-SNR or based on a noisy speech power used in minima tracking.

An example in which the second noise estimator 400 uses a confidential weighted score based on a prior-SNR will be described below.

The second noise σ_{Ni}(τ,k) with improved accuracy, which is denoted in FIG. 4, may be calculated by Equation 9 below.

σ_{N}_{ᵢ}(τ,k)=(1−Mᵢ(τ,k))|Xᵢ(τ,k)|+Mᵢ(τ,k)|Nᵢ(τ,k)|, i=1,2 (9)

In Equation 9, the confidential weighted score Mᵢ(τ,k) may be defined according to a prior-SNR, which is expressed by Equation 10 below.

$${M}_{i} ( τ , k ) = \frac{1}{1 + exp \{ - {φ}_{th} ( \frac{\vert S ( τ - 1 , k ) \vert}{\vert {N}_{i} ( τ - 1 , k ) \vert} - {θ}_{th} ) \}} \qquad ( 10 )$$

In Equation 10, φ and θ represent a slope and a threshold value, respectively.

Referring to Equations 9 and 10, in a low SNR environment, since the confidential weighted score approaches 0, an input signal itself may be considered as noise, and in a high SNR environment, since the confidential weighted score approaches 1, a primarily estimated noise may be considered as noise.

An example in which the second noise estimator 400 uses a confidential weighted score based on a noisy speech power used in minima tracking will be described below.

First, the second noise σ_{Ni}(τ,k) with improved noise estimation accuracy, which is denoted in FIG. 4, is as follows.

σ_{N}_{ᵢ}(τ,k)=(1−Mᵢ(τ,k))|Xᵢ(τ,k)|+Mᵢ(τ,k)|Nᵢ(τ,k)|, i=1,2 (11)

In Equation 11, a confidential weighted score Mᵢ(τ,k) may be defined by Equation 12, using a power spectrum ratio between noisy speech and noise estimated considering the relationship between adjacent frequencies upon noise estimation based on minima tracking, below.

$$M ( τ , k ) = g ( z ( τ , k ) , φ , θ ) \\ where , g ( z , φ , θ ) = \frac{1}{1 + exp ( - φ ( z - θ ) )} \\ z ( τ , k ) = 10 {log}_{10} ( \frac{{\vert X ( τ , k ) \vert}^{2}}{{P}_{min} ( τ , k ) + ε} ) \qquad ( 12 )$$

In Equation 12, φ and θ represent a slope and threshold value of a sigmoid function, respectively, and ε is a constant used to prevent a denominator from becoming zero. A ratio of a flattened noisy speech power to the original noisy speech power may be calculated by Equation 13 below.

$${P}_{i} ( τ , k ) = η \cdot {P}_{i} ( τ - 1 , k ) + ( 1 - η ) \cdot {\sum }_{l = k - N}^{k + N} {\vert {X}_{i} ( τ , l ) \vert}^{2} \\ if {P}_{i , min} ( τ - 1 , k ) < {P}_{i} ( τ , k ) \\ then {P}_{i , min} ( τ , k ) = γ {P}_{i , min} ( τ - 1 , k ) + \frac{1 - γ}{1 - β} [ {P}_{i} ( τ , k ) - β {P}_{i} ( τ - 1 , k ) ] \\ else {P}_{i , min} ( τ , k ) = {P}_{i} ( τ , k ) \qquad ( 13 )$$

It can be seen in Equation 13 that

$${\sum }_{l = k - N}^{k + N} {\vert {X}_{i} ( τ , l ) \vert}^{2}$$

may be used as a power spectrum of a basic noisy speech. This is aimed at considering the relationship between adjacent frequencies in estimating noise using minima tracking. In this way, signals at adjacent frequencies may be considered in calculating minima power, which may contribute to significantly reduce musical noise components. In Equation 13, γ, η β and are constants indicating a flattened level of a power spectrum, a flattened level of a minimum power spectrum, and a look-ahead factor, respectively.

Meanwhile, since the power spectrum of a speech signal may be relatively strong at low frequency regions and relatively weak at high frequency regions, maintaining the threshold value of a sigmoid function constant over all frequencies may cause a confidential weighted score for a high frequency signal to be a relatively small value. Accordingly, it may also be possible to increase the threshold value at low frequencies (<1 KHz) and decrease the threshold value at high frequencies (>3 KHz).

FIG. 5 is a diagram illustrating an example target signal estimator 500.

In FIG. 5, the target signal estimator 500 may estimate a target signal S(τ,k) by removing noise from input signals X₁(τ,k) and X₂(τ,k) transformed into a complex spectrum domain. Noise that will be used for target signal estimation may be noise signals N₁(τ,k) and N₂(τ,k) estimated by the first noise estimator (e.g., 200 of FIG. 2 or 300 of FIG. 3) or noise signals σ_{N1}(τ,k) and σ_{N2}(τ,k) estimated by the second noise estimator (e.g., 400 of FIG. 4).

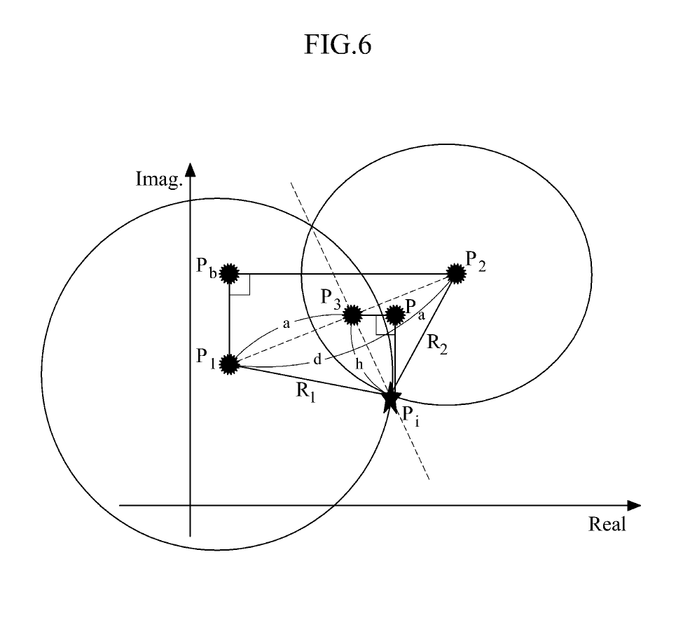

FIG. 6 is a view for explaining a target signal estimating method that is performed by a target signal estimator 500.

In FIG. 6, the target signal estimator 500 of FIG. 5 may represent candidates of a target signal as two circles in a complex spectrum domain. The centers of the respective circles Pₓ may be input signals and the radius Rₓ of each circle may correspond to noise.

For example, P₁ is a point on a complex space corresponding to an input signal X₁(τ,k), and P₂ is a point on the complex space corresponding to an input signal X₂(τ,k). Also, R₁ and R₂ may be noise signals included in the input signals X₁(τ,k) and X₂(τ,k), respectively, and the circles may be candidates of a target signal.

The target signal estimator 500 may determine R₁ and R₂ values using noise signals estimated by the first noise estimator or by the second noise estimator, obtains intersections of the two circles, and then estimates the intersection located nearer the origin, among the intersections, as a target signal.

This process will be described in more detail with related Equations, below.

It may be presumed that the radiuses of circles are determined according to the magnitudes of noise spectrums that are received through two microphones are R₁ and R₂, respectively, and intersections of the two circles are Pᵢ. If the length of a P₁P₂ segment connecting the centers of the two circles is “d”, a point at which the P₁P₂ segment intersects a segment connecting the intersections of the two circles is P₃, the length of a P₁P₃ segment is “a” and the length of a P₃Pᵢ segment is “h”, the following equations may be obtained from the Pythagorean theorem with respect to triangles P₁P₃Pᵢ and P₂P₃Pᵢ.

a²+h²=R₁², (d−a)²+h²=R₂² (14)

By rewriting Equation 14, the coordinate value of the point P₃ may be calculated as follows.

$${P}_{3} = {P}_{1} + \frac{a}{d} ( {P}_{2} - {P}_{1} ) , a = \frac{{R}_{1}^{2} - {R}_{2}^{2} + {d}^{2}}{2 d} \qquad ( 15 )$$

Meanwhile, if a point at which a segment extending parallel to the imaginary axis from P₁ intersects a segment extending parallel to the real axis from P₂ is P_{b} and a point at which a segment extending parallel to the imaginary axis from Pᵢ intersects a segment extending parallel to the real axis from P₃ is Pₐ, triangles P₁P₂P_{b} and PᵢP₃Pₐ may become similar triangles and accordingly, the intersection Pᵢ may be obtained as follows.

$${P}_{i} = ( {x}_{i} , {y}_{i} ) = {P}_{3} \pm \frac{h}{d} ( {P}_{1} - {P}_{2} ) \\ where , {x}_{i} = {x}_{3} \pm \frac{h}{d} ( {y}_{2} - {y}_{1} ) , {y}_{i} = {y}_{3} ∓ \frac{h}{d} ( {x}_{2} - {x}_{1} ) \qquad ( 16 )$$

In Equation 16, the intersection located nearer the origin, among the two intersections, may be chosen as a target signal.

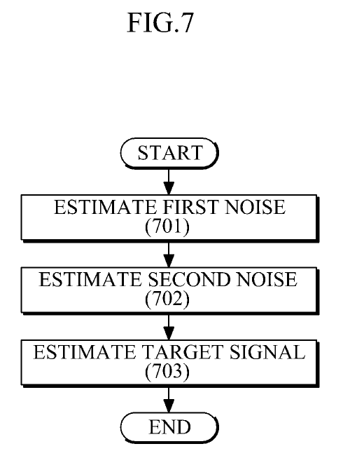

Then, an example noise reduction method will be described with reference to FIG. 7.

Referring to FIG. 7, in operation 701, a first noise included in an input signal may be estimated. For example, the first noise estimator (e.g., first noise estimator 101 of FIG. 1) may estimate first noise using Equations 1 through 8. The first noise may be estimated using an adaptive blocking matrix, and a filter learning coefficient of a learning filter for noise estimation may be updated according to a prior-SNR.

In operation 702, a second noise may be estimated with more improved noise estimation accuracy based on the first noise. For example, the second noise estimator (e.g., the second noise estimator 102 of FIG. 1) may estimate the second noise using Equations 9 through 13. A confidential weighted score for estimation of the second noise may be defined based on the prior-SNR or based on a noisy speech power using minimal tracking in consideration of the relationship between adjacent frequencies

In operation 703, a target signal may be estimated from the input signal using the estimated first or second noise. For example, the target signal estimator (e.g., the target signal estimator 103 of FIG. 1) may estimate a target signal using Equations 14 through 16. The estimated first or second noise may be set as the radius of a circle.

As described above, according to the above-described embodiments, by accurately estimating noise from a mixed signal and calculating a target signal based on the estimated noise, accurate estimation of a target signal is achieved.

The processes, functions, methods and/or software described above may be recorded, stored, or fixed in one or more computer-readable storage media that includes program instructions to be implemented by, a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for reducing noise to extract a target signal contained in input signals received through at least two microphones, the apparatus comprising:
a first noise estimator configured to estimate first noise using a filter comprising a filter learning coefficient configured to be updated according to a prior signal-to-noise ratio.

2. The apparatus of claim 1, further comprising a second noise estimator configured to estimate second noise using:
the first noise; and
a confidential weighted score that is determined based on a signal-to-noise ratio.

3. The apparatus of claim 2, wherein the confidential weighted score is determined based on the prior signal-to-noise ratio.

4. The apparatus of claim 2, wherein the confidential weighted score is determined based on a flattened noisy speech power using minima tracking.

5. The apparatus of claim 1, further comprising:
a target signal estimator configured to estimate the target signal by:
representing the target signal as at least two circles in a complex spectrum domain; and
determining intersections of the circles,
wherein the input signals are set as centers of the circles and the first noise is set as a radius of each circle.

6. The apparatus of claim 2, further comprising:
a target signal estimator configured to estimate the target signal by:
representing the target signal as at least two circles in a complex spectrum domain; and
determining intersections of the circles,
wherein the input signals are set as centers of the circles and the second noise is set as a radius of each circle.

7. An apparatus for reducing noise to extract a target signal included in input signals received through at least two microphones, the apparatus comprising:
a first noise estimator configured to estimate first noise using an adaptive blocking matrix; and
a second noise estimator configured to estimate second noise using:
the first noise; and
a confidential weighted score that is defined based on a signal-to-noise ratio.

8. The apparatus of claim 7, wherein the confidential weighted score is defined based on a prior signal-to-noise ratio.

9. The apparatus of claim 7, wherein the confidential weighted score is defined based on a flattened noisy speech power using minima tracking.

10. The apparatus of claim 7, further comprising:
a target signal estimator configured to estimate the target signal by:
representing the target signal as at least two circles in a complex spectrum domain; and
determining intersections of the circles,
wherein the input signals are set as centers of the circles and the second noise is set as a radius of each circle.

11. A method of reducing noise to extract a target signal included in input signals received through at least two microphones, the method comprising:
estimating first noise through a filter comprising a filter learning coefficient that is updated according to an adaptive blocking matrix or a prior signal-to-noise ratio.

12. The method of claim 11, further comprising estimating second noise using:
the first noise; and
a confidential weighted score that is defined based on a signal-to-noise ratio.

13. The method of claim 12, further comprising estimating the target signal by:
representing the target signal as at least two circles in a complex spectrum domain; and
obtaining intersections of the circles,
wherein the input signals are set as centers of the circles and the first noise or the second noise is set as a radius of each circle.

14. The method of claim 11, wherein the confidential weighted score is defined based on a prior signal-to-noise ratio.

15. The method of claim 11, wherein the confidential weighted score is defined based on a flattened noisy speech power using minima tracking.
